(19) United States
(12) Patent Application Publication
(10) Pub. No.: US 2007/0174061 A1
(43) Pub. Date: Jul. 26, 2007

(54) Mpeg audio decoding method

(76) Inventors: Hideyuki Kakuno, Osaka (JP); Masahiro Sueyoshi, Osaka (JP); Kosuke Nishio, Osaka (JP)

Correspondence Address: MCDERMOTT WILL & EMERY LLP, 600 13TH STREET, NW, WASHINGTON, DC, 20005-3096, US

(21) Appl. No.: 10/590,009

(22) PCT Filed: Dec. 12, 2005
(86) PCT No.: PCT/JP05/22771

§ 371 Date: Aug. 21, 2006

(30) Foreign Application Priority Data
Dec. 22, 2004 (JP) 2004-371609

(51) Int. Cl. G10L 19/00

(52) U.S. Cl. 704/500

(57) ABSTRACT

In a compression process (S10), each allocation table is converted by reducing each group of subbands sharing a common pattern to one (S11), and the allocation tables are further converted into a single table (S12). Then, offset values each corresponding to one subband are defined in a table (S13), and these tables are stored in the memory (S14). In a decoding process (S20), an offset value is obtained using a subband as a key (S21), and the number of quantization steps is obtained from a pattern read out from the table using the offset value (S22).

### RELATED APPLICATION

This application is a national phase of PCT/JP2005/022771 filed on Dec. 12, 2005, which claims priority from Japanese Application No. 2004-371609 filed on Dec. 22, 2004, the disclosures of which Applications are incorporated by reference herein. The benefit of the filing and priority dates of the International and Japanese Applications is respectfully requested.

### TECHNICAL FIELD

The present invention relates to MPEG audio decoding for decoding an audio stream obtained by compressing audio data and, more particularly, to an MPEG audio decoding method for improving the decoding of an MPEG audio stream in devices such as DVD players, DVD recorders, and tuners for digital broadcasting.

### BACKGROUND ART

In a conventional MPEG audio decoding method, an allocation table defining the number of quantization steps requires 1 kbyte (=32 bytes×16×2) of storage area per table. Therefore, if there are five allocation tables, it is necessary to provide a 5 kbytes of memory. In view of this, there is a method for compressing the allocation tables for reducing the memory (see, for example, Patent Document 1).

Patent Document 1: European Patent Application Publication No. EP 0918400

### DISCLOSURE OF THE INVENTION

Problems to be Solved by the Invention

However, it has not been possible with conventional methods to sufficiently reduce the amount of memory used. For example, in Patent Document 1, the allocation table is compressed, thus reducing the required storage area down to 1940 bytes. However, this is data compression of only about 62%, and is not a sufficient reduction of memory area. Another problem is that the decoding algorithm is slightly complicated.

In view of the problem, it is an object of the present invention to provide an MPEG audio decoding method, with which it is possible to decode data with a simple algorithm while significantly reducing the data amount needed in the allocation table.

Means for Solving The Problems

The present invention provides an MPEG audio decoding method for decoding an audio stream, including: a compression process of compressing a plurality of allocation tables used when searching for the number of quantization steps and storing a compressed table in a memory; and a decoding process of decoding the number of quantization steps by using the compressed table stored in the memory. The compression process includes: a first step of converting each said allocation table by reducing each group of subbands sharing a pattern to one, said pattern representing a relationship between an index value and the number of quantization steps; a second step of converting the converted allocation tables into a single first table by reducing each group of subbands sharing said pattern to one; and a third step of defining, in a second table, offset values each corresponding to one subband, which are used for referencing the first table; the compression process stores the first and second tables, as the compressed table, in the memory; and the decoding process includes: a first step of obtaining an offset value by referencing the second table using a subband as a key; and a second step of referencing the first table using the offset value obtained in the first step to obtain the number of quantization steps from said pattern read out.

According to this invention, in the compression process, each allocation table is converted by reducing each group of subbands sharing a common pattern to one, and the converted allocation tables are converted into a single first table by reducing each group of subbands sharing a common pattern to one. Moreover, offset values each corresponding to one subband, which are used for referencing the first table, are defined in a second table, and the first and second tables are stored in the memory as compressed tables. Thus, subbands of the same pattern are all omitted, whereby it is possible to significantly reduce the data amount of the allocation table. In the decoding process, an offset value is obtained by referencing the second table using a subband as a key, and the first table is referenced using the offset value to obtain the number of quantization steps from a read-out pattern. Thus, it is possible to perform the decoding operation with a relatively simple algorithm.

Preferably, in the second step of the compression process, the first table is further converted by using a bit allocation where each bit uniquely represents the number of quantization steps. Thus, it is possible to further reduce the data amount of the first table.

Effects of the Invention

According to the present invention, it is possible to significantly reduce the data amount of the allocation table and to perform the decoding operation with a relatively simple algorithm. Thus, it is possible to reduce the memory, whereby it is also possible to reduce the LSI chip area and to thus reduce the chip cost.

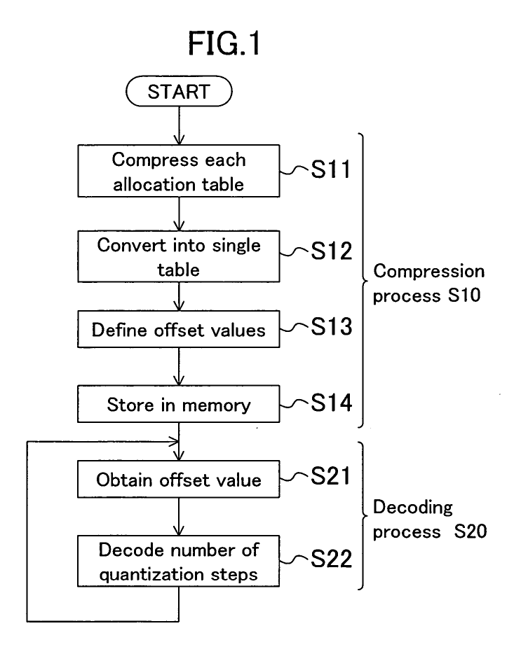

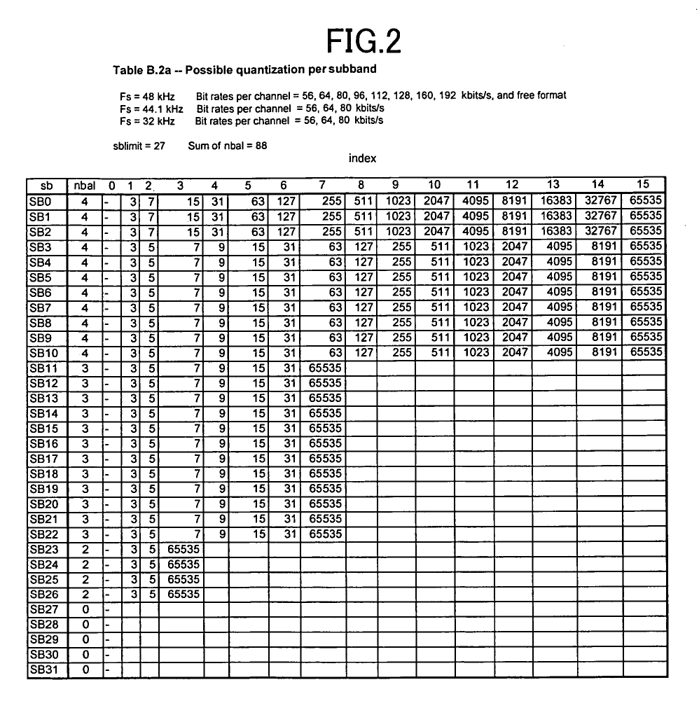

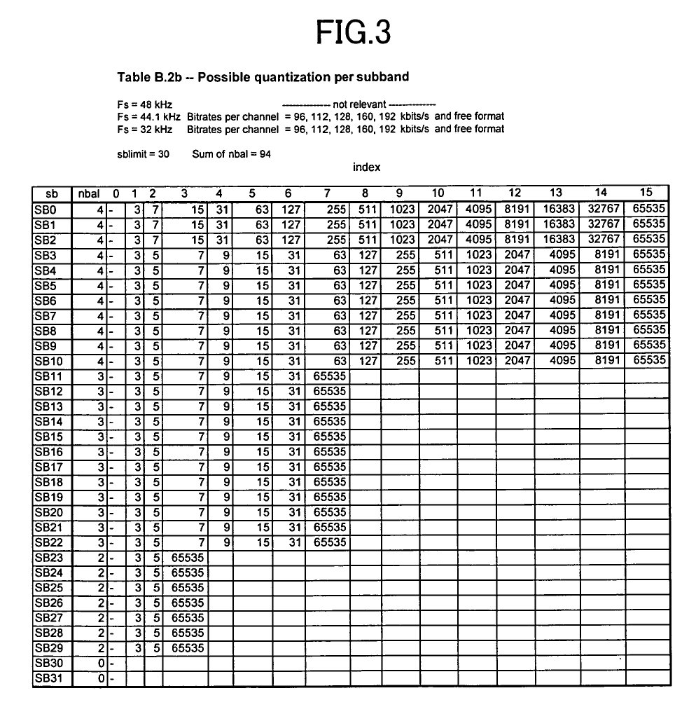

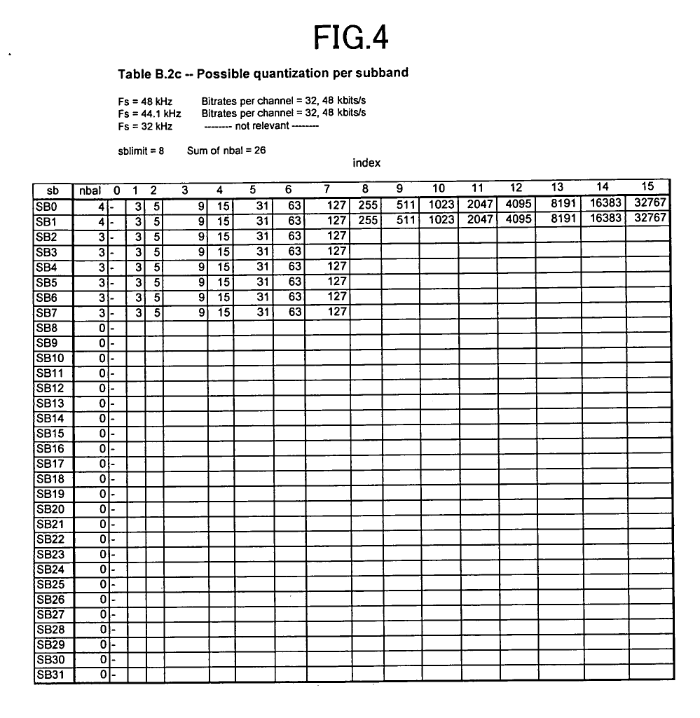

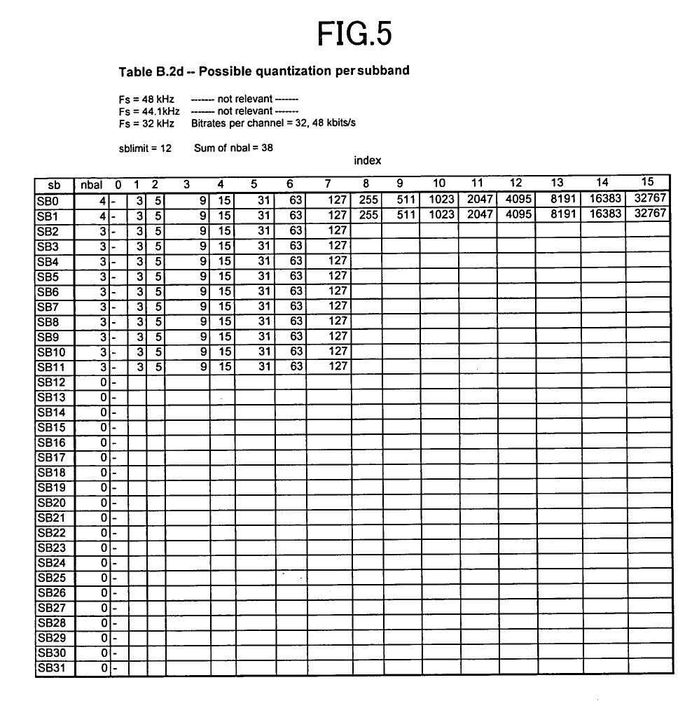

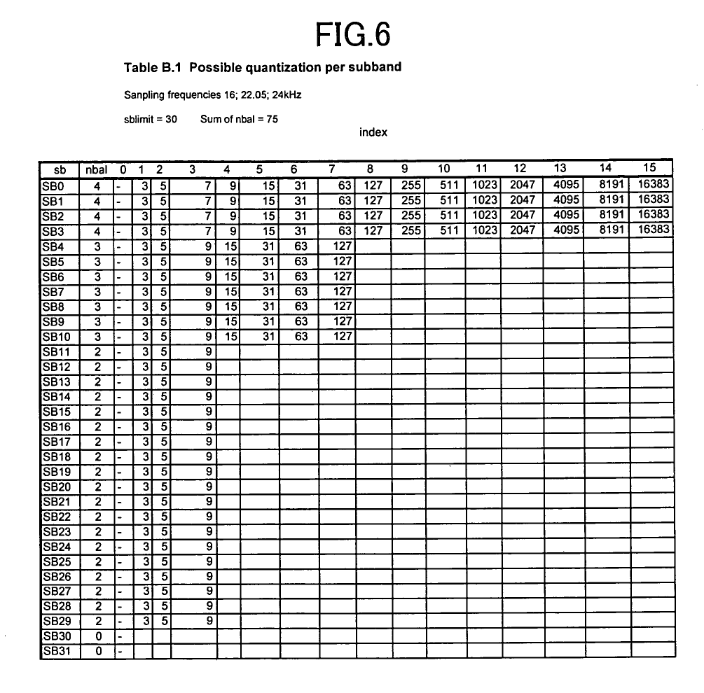

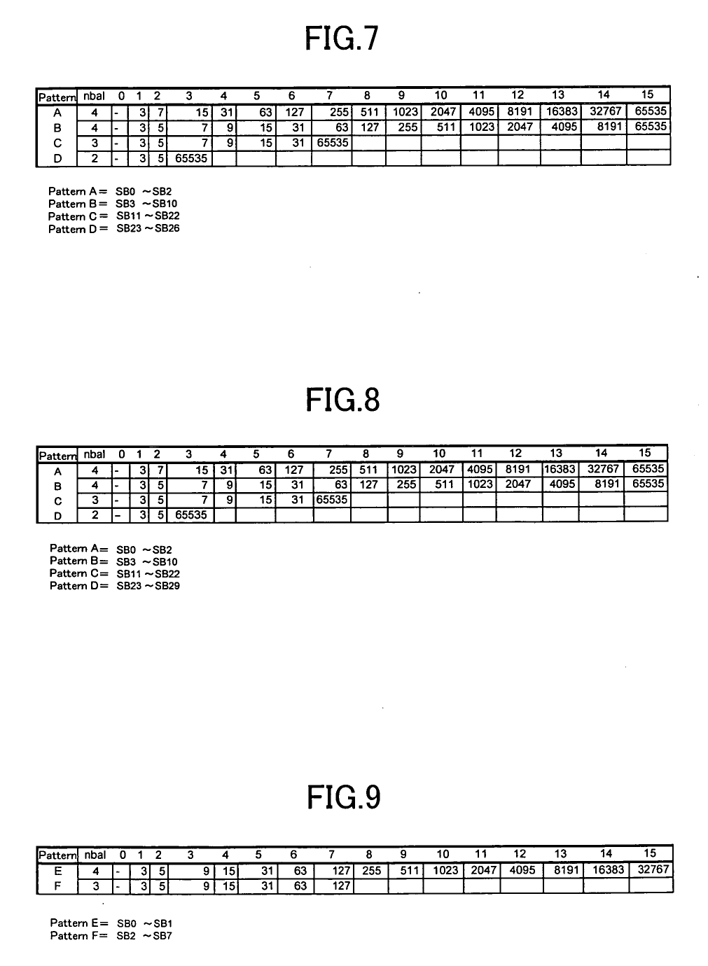

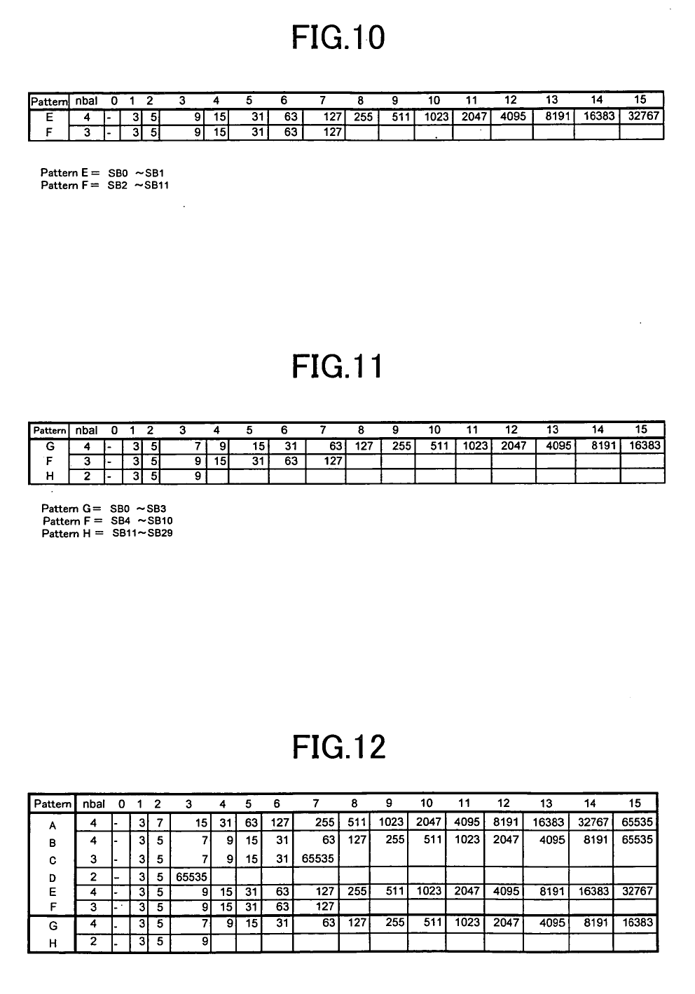

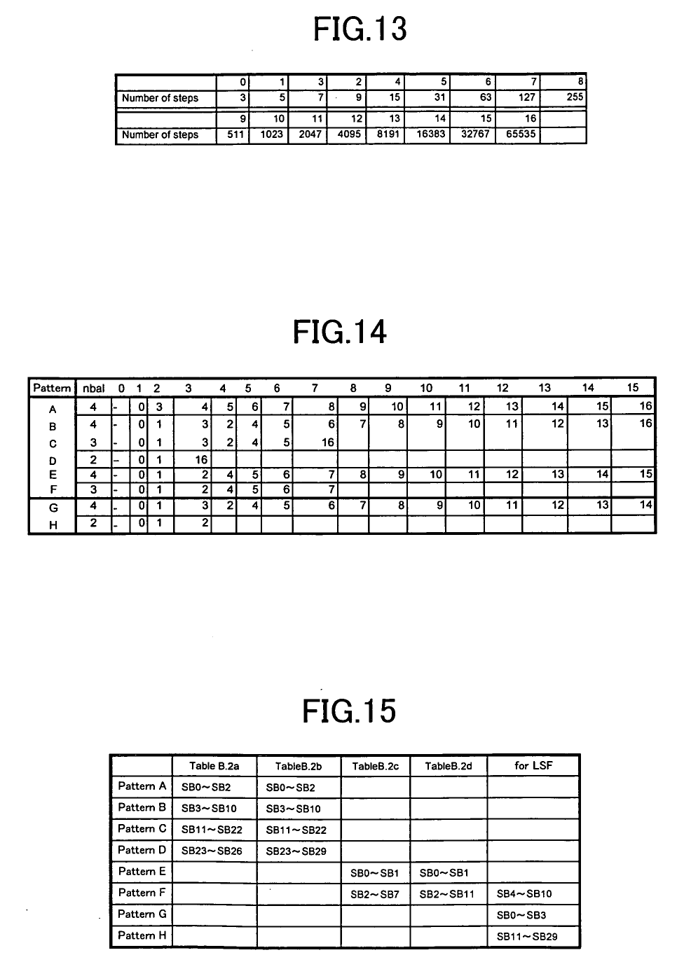

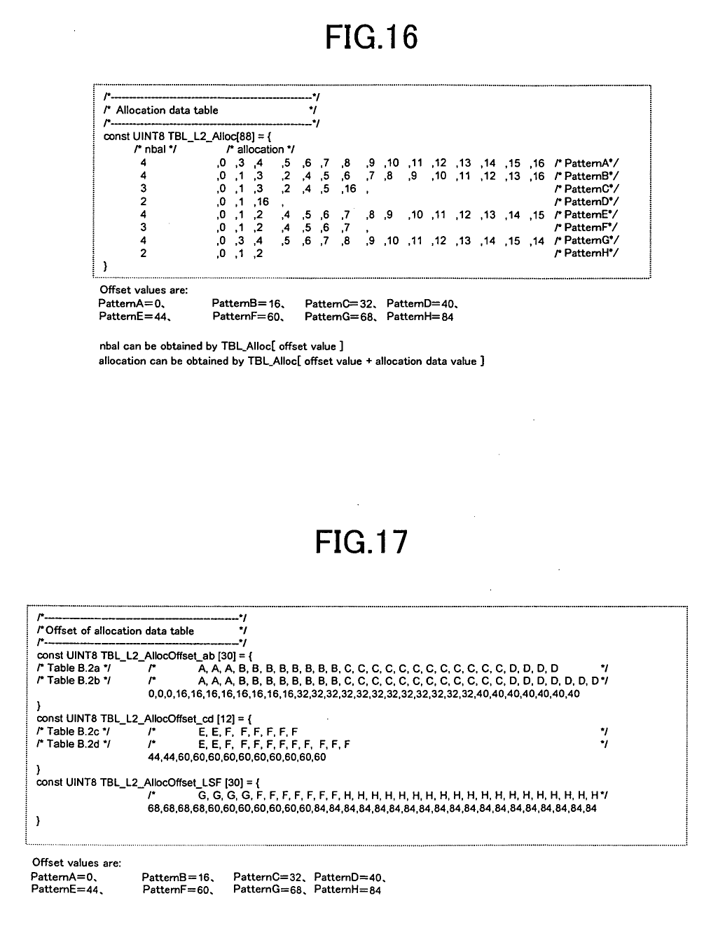

### BRIEF DESCRIPTION OF THE DRAWINGS

[FIG. 1] FIG. 1 is a flow chart showing an MPEG audio decoding method according to an embodiment of the present invention.

[FIG. 2] FIG. 2 is an example of an allocation table.

[FIG. 3] FIG. 3 is an example of an allocation table.

[FIG. 4] FIG. 4 is an example of an allocation table.

[FIG. 5] FIG. 5 is an example of an allocation table.

[FIG. 6] FIG. 6 is an example of an allocation table.

[FIG. 7] FIG. 7 shows a table similar to FIG. 2, except that each group of subbands sharing a common pattern are reduced to one.

[FIG. 8] FIG. 8 shows a table similar to FIG. 3, except that each group of subbands sharing a common pattern are reduced to one.

[FIG. 9] FIG. 9 shows a table similar to FIG. 4, except that each group of subbands sharing a common pattern are reduced to one.

[FIG. 10] FIG. 10 shows a table similar to FIG. 5, except that each group of subbands sharing a common pattern are reduced to one.

[FIG. 11] FIG. 11 shows a table similar to FIG. 6, except that each group of subbands sharing a common pattern are reduced to one.

[FIG. 12] FIG. 12 shows a table obtained by grouping the contents of the tables of FIGS. 7 to 11.

[FIG. 13] FIG. 13 shows an example of a bit allocation by which the number of quantization steps is uniquely represented by a bit.

[FIG. 14] FIG. 14 shows a table obtained by converting the table of FIG. 12 by the bit allocation of FIG. 13.

[FIG. 15] FIG. 15 shows a second table showing an offset value defined for each subband.

[FIG. 16] FIG. 16 shows an example of how data of FIG. 14 are arranged in a memory.

[FIG. 17] FIG. 17 shows an example of how data of FIG. 15 are arranged in a memory.

### DESCRIPTION OF REFERENCE NUMERALS

S10 Compression process

S11 First step

S12 Second step

S13 Third step

S20 Decoding process

S21 First step

S22 Second step

### BEST MODE FOR CARRYING OUT THE INVENTION

An embodiment of the present invention will now be described with reference to the drawings.

FIG. 1 is a flow chart showing an MPEG audio decoding method according to an embodiment of the present invention. As shown in FIG. 1, the MPEG audio decoding method of the present embodiment includes a compression process S10 of compressing a plurality of allocation tables used when searching for the number of quantization steps and storing a compressed table in a memory, and a decoding process S20 of decoding the number of quantization steps by using the compressed table stored in the memory.

In step S11 as the “first step” of the compression process S10, the allocation tables are converted so that by reducing each group of subbands sharing a common pattern representing the relationship between the index value and the number of quantization steps to one. Then, in step S12 as the “second step”, the converted allocation tables are converted into a single first table by reducing each group of subbands sharing a common pattern to one. In step S13 as the “third step”, offset values each corresponding to one subband, which are used for referencing the first table, are defined in the second table. In step S14, the first table obtained in step S12 and the second table obtained in step S13 are stored in the memory as a compressed table.

In step S21 as the “first step” of the decoding process S20, the second table is referenced using a subband as a key so as to obtain an offset value. Then, in step S21, the first table is referenced using the obtained offset value so as to obtain the number of quantization steps based on the read-out pattern. Steps S21 and S22 are repeatedly performed each time the number of quantization steps needs to be decoded.

FIGS. 2 to 6 are an example of a plurality of allocation tables. FIGS. 2 to 5 are Table B.2a, Table B.2b, Table B.2c and Table B.2d, respectively, in ISO/IEC 11172-3:1993(E) Annex B Table B.2—Layer II bit allocation tables, and FIG. 6 is ISO/IEC 13181-3:1997(E) Annex B Table B.1.

The allocation tables of FIGS. 2 to 6 contain a pattern for each subband (scale factor band information) representing the relationship between the index value and the number of quantization steps. Note that “nbal” represents the number of bits when reading out index information from a stream. The allocation tables are classified based on the sampling rate and the bit rate, and an allocation table to be referenced is uniquely determined by the sampling rate and the bit rate.

Normally, the procedure for decoding the number of quantization steps is as follows. First, the allocation tables of FIGS. 2 to 6 are referenced and an nbal [bits]-portion of the stream is read out for each subband, thus obtaining the read-out value as the index information. Then, the number of quantization steps is obtained from FIGS. 2 to 6 using the subband and the index information.

In the compression process S10 of the present embodiment, the allocation tables of FIGS. 2 to 6 are compressed and stored in the memory.

First, in each allocation table, each group of subbands sharing a common pattern are reduced to one (S11). Thus, the allocation tables of FIGS. 2 to 6 are converted to tables as shown in FIGS. 7 to 11.

Then, the converted allocation tables are converted into a single table by reducing each group of subbands sharing a common pattern to one (S12). Thus, the tables of FIGS. 7 to 11 are put together into a single table as shown in FIG. 12. By using a bit allocation where each bit uniquely represents one number of quantization steps, it is possible to further reduce the data amount. For example, using a bit allocation as shown in FIG. 13, the number of quantization steps, whose representation otherwise needs two bytes, can be represented by one byte. As a result, a table as shown in FIG. 14 is obtained. Note that it is of course possible to leave the numbers of quantization steps as they are in the table without using a bit allocation.

Then, offset values, each corresponding to one subband, which are used for referencing a single table as shown in FIG. 14, are defined (S13). FIG. 15 is a table showing the defined offset values. With the offset values defined for subbands in the original allocation tables, i.e., FIGS. 2 to 6, as shown in FIG. 15, it is possible to obtain the number of quantization steps by referencing the table of FIG. 14.

Then, the data obtained from the specified table is stored in the memory (S14). Specifically, the data of the table of FIG. 14 is set in the memory as shown in FIG. 16, and the data of the table of FIG. 15 is set in the memory as shown in FIG. 17.

For each of the allocation tables, i.e., FIGS. 2 to 6, the value of nbal is 0 for any subband greater than or equal to the predetermined value sblimit. Since these table portions do not need to be referenced, it is not necessary to provide offset values therefor. As can be seen from the table of FIG. 15, FIG. 2 (Table B.2a) can be merged with FIG. 3 (Table B.2b), and FIG. 4 (Table B.2c) can be merged with FIG. 5 (Table B.2d). Therefore, it is only necessary to provide offset values for subbands shown in the allocation tables of FIGS. 3, 5 and 6. As a result, data to be set in the memory is as shown in FIG. 17.

The amount of data shown in FIGS. 16 and FIG. 17 is 160 bytes. Thus, as compared with the original allocation tables requiring 5 kbytes, a data compression by about 97% is realized.

Moreover, the decoding process S20 can be performed with a relatively simple algorithm. For example, where Fs=48 kHz and Bit rate=56 kbits/s in MPEG-1 Layer II, decoding is supposedly performed by using the table of FIG. 2 (Table B.2a). Therefore, in the data of FIG. 17, TBL_L2_AllocOffset_ab is used as the allocation table offset. Where sb=3 and allocation (index)=2,

(1) Referencing the data of FIG. 17, offset=16 (Pattern B) is obtained from TBL_{—L2}_AllocOffset_ab[sb],

(2) Referencing the data of FIG. 16, nbal=4 is obtained from TBL_L2_Alloc[offset],

(3) Number of steps index=1 is obtained from TBL_L2_Alloc[offset+allocation], and

(4) Number of quantization steps=5 is obtained from the conversion table of FIG. 13.

(1) corresponds to step S21, and (2) to step S22. Thus, it is possible to decode the number of quantization steps with a simple algorithm.

### INDUSTRIAL APPLICABILITY

The present invention allows for a significant reduction in the data amount of the allocation table and can be carried out with a relatively simple algorithm. Therefore, the present invention allows for a reduction in memory in devices such as DVD players, DVD recorders, and tuners for digital broadcasting, thereby effectively reducing the cost.

1. An MPEG audio decoding method for decoding an audio stream, comprising:
a compression process of compressing a plurality of allocation tables used when searching for the number of quantization steps and storing a compressed table in a memory; and
a decoding process of decoding the number of quantization steps by using the compressed table stored in the memory, wherein:
the compression process includes:
a first step of converting each said allocation table by reducing each group of subbands sharing a pattern to one, said pattern representing a relationship between an index value and the number of quantization steps;
a second step of converting the converted allocation tables into a single first table by reducing each group of subbands sharing said pattern to one; and
a third step of defining, in a second table, offset values each corresponding to one subband, which are used for referencing the first table;
the compression process stores the first and second tables, as the compressed table, in the memory; and
the decoding process includes:
a first step of obtaining an offset value by referencing the second table using a subband as a key; and
a second step of referencing the first table using the offset value obtained in the first step to obtain the number of quantization steps from said pattern read out.

2. The MPEG audio decoding method of claim 1, wherein in the second step of the compression process, the first table is further converted by using a bit allocation where each bit uniquely represents the number of quantization steps.
